(19) United States
(12) Patent Application Publication
(10) Pub. No.: US 2021/0383492 A1
(43) Pub. Date: Dec. 9, 2021

(54) TEXT GENERATION DEVICE, TEXT GENERATION METHOD, AND NON-TRANSITORY COMPUTER-READABLE MEDIUM

(71) Applicant: Al Samurai Inc., Tokyo (JP)

(72) Inventor: Takashi MIKAMI, Tokyo (JP)

(73) Assignee: Al Samurai Inc., Tokyo (JP)

(21) Appl. No.: 17/412,591

(22) Filed: Aug. 26, 2021

Related U.S. Application Data
(63) Continuation of application No. PCT/JP2019/022031, filed on Jun. 3, 2019.

(51) Int. Cl. G06Q 50/18; G06F 40/40; G06F 40/279; G06F 16/28

(52) U.S. Cl. CPC G06Q 50/184; G06F 16/285; G06F 40/279; G06F 40/40

(57) ABSTRACT

A text generating device including at least one processor, and at least one memory including computer program code, wherein the at least one memory and the computer program code are configured to, with the at least one processor, cause the text generating device to determine a first patent classification of invention text, select a second patent classification corresponding to the first patent classification, extract a patent document corresponding to the second patent classification from a patent document database, the patent document being similar to the invention text, generate additional invention text associated with the invention text based on the patent document, the additional invention text being included in the patent document and not included in the invention text, and transmit the additional invention text to a terminal device.

### CROSS-REFERENCE TO RELATED APPLICATIONS

This U.S. non-provisional application is a continuation of, and claims the benefit of priority under 35 U.S.C. § 365(c) from International Patent Application No. PCT/JP2019/022031 filed on Jun. 3, 2019 in the World Intellectual Property Organization (WIPO), the contents of which are incorporated herein by reference in their entirety.

### BACKGROUND

### Technical Field

Some example embodiments relate to a text generating device, a text generating method, and/or a non-transitory computer-readable medium.

### Description of Related Art

Patent applicants or patent attorneys' offices examine whether subject matter of an invention has patentability before filing a patent application. In a first technique, patentability of a patent to be evaluated is determined independently of manual patent searching by acquiring patent features from a predetermined or alternatively, given group of patent documents on the basis of subject classification indices.

A patent applicant or a patent attorneys' office prepares a specification for a patent application for a patentable invention and presents the specification to the Patent Office. Preparation of a specification for a patent application involves human labor and automation thereof has been studied. A second technique exists for receiving inventor information, or a technical information file from a terminal device which is carried by an engineer, and automatically generating a specification for a patent application. A patent applicant or a patent attorneys' office may automatically prepare a specification for a patent application using the second technique.

### SUMMARY

However, in the first technique, it may be determined whether the subject matter of an invention input by a user has patentability, but a process for improving patentability of the subject matter with low patentability when the patentability thereof is determined to be low is not performed. Similarly, in the second technique, a specification for a patent application is completed on the basis of received technical information regardless of patentability.

That is, none of the techniques provides any support when the subject matter of an invention input by a user has poor patentability.

Therefore, in consideration of the aforementioned challenges, some example embodiments provide a text generating device, a text generating method, and/or a non-transitory computer readable medium storing a text generating program that, when executed by a computer, is able to automatically propose a configuration with high patentability, for example, by increasing claim scope, adding detail to specification, etc., even when subject matter with poor patentability is input by a user.

(1) According to some example embodiments, there is provided a text generating device including at least one processor, and at least one memory including computer program code, wherein the at least one memory and the computer program code are configured to, with the at least one processor, cause the text generating device to determine a first patent classification of invention text, select a second patent classification corresponding to the first patent classification, extract a patent document corresponding to the second patent classification from a patent document database, the patent document being similar to the invention text, generate additional invention text associated with the invention text based on the patent document, the additional invention text being included in the patent document and not included in the invention text, and transmit the additional invention text to a terminal device.

(2) The text generating device according to the configuration of (1) may further include a patent classification database configured to store the first patent classification and the second patent classification in correlation with each other, and the at least one memory and the computer program code may be configured to, with the at least one processor, cause the text generating device to select the second patent classification from the patent classification database.

(3) In the text generating device according to the configuration of (1), the at least one memory and the computer program code may be configured to, with the at least one processor, cause the text generating device to extract patent text of the first patent classification from the patent document database, the patent text being similar to the invention text, and select a patent classification assigned to the patent text or a patent classification assigned to a prior art document correlated with the patent text as the second patent classification.

(4) In the text generating device according to any one of the configurations of (1) to (3), the at least one memory and the computer program code may be configured to, with the at least one processor, cause the text generating device to select a plurality of second patent classifications including the second patent classification, transmit the plurality of second patent classifications to the terminal device, receive an input selection of at least one selected second patent classification among the plurality of second patent classifications from the terminal device, and extract the patent document corresponding to the selected second patent classification.

(5) In the text generating device according to any one of the configurations of (1) to (4), the at least one memory and the computer program code may be configured to, with the at least one processor, cause the text generating device to extract the patent document from the patent document database based on the patent document being most similar to the invention text among a plurality of patent documents corresponding to the second patent classification.

(6) In the text generating device according to any one of the configurations of (1) to (4), the at least one memory and the computer program code may be configured to, with the at least one processor, cause the text generating device to extract a plurality of patent documents corresponding to a plurality of second patent classifications from the patent document database, the plurality of patent documents including the patent document, and the plurality of second patent classifications including the second patent classification, and generate the additional invention text based on common text in the plurality of patent documents, the common text being common among the plurality of patent documents and dissimilar to the invention text. (7) In the text generating device according to any one of the configurations of (1) to (6), the at least one memory and the computer program code may be configured to, with the at least one processor, cause the text generating device to generate a specification of a patent application or at least one claim of the patent application based on the invention text and the additional invention text, generate a signal corresponding to the specification or the at least one claim, and/or transmit the signal to the terminal device.

(8) According to some example embodiments, there is provided a text generating method performed by a computer, the method including determining a first patent classification of invention text, selecting a second patent classification corresponding to the first patent classification, extracting a patent document corresponding to the second patent classification from a patent document database, the patent document being similar to the invention text, generating additional invention text associated with the invention text based on the patent document, and transmitting the additional invention text to a terminal device.

(9) According to some example embodiments, there is provided a non-transitory computer-readable medium storing a text generating program that, when executed by a computer, causes a device including the computer to determine a first patent classification of invention text, select a second patent classification corresponding to the first patent classification, extract a patent document corresponding to the second patent classification from a patent document database, the patent document being similar to the invention text, generate additional invention text associated with the invention text based on the patent document, and transmit the additional invention text to a terminal device.

According to some example embodiments, it is possible to provide a text generating device, a text generating method, and/or a non-transitory computer readable medium storing a text generating program that, when executed by a computer, is able to automatically propose a configuration with high patentability even when the subject matter with poor patentability (e.g., involving a subject matter in which many patent documents have been filed) is input by a user.

### BRIEF DESCRIPTION OF THE DRAWINGS

FIG. 1 is a diagram schematically illustrating an example of a routine which is performed by a text generating system 1.

FIG. 2 is a diagram schematically illustrating an example of a configuration of the text generating system 1.

FIG. 3 is a diagram schematically illustrating an example of a configuration of a user terminal device 2.

FIG. 4 is a diagram schematically illustrating an example of a configuration of a server 4.

FIG. 5 is a diagram illustrating an example of an operation sequence of a flow of receiving invention text from a user terminal device 2, generating additional invention text, and transmitting the generated additional invention text to the user terminal device 2, which is performed by the text generating system 1 according to some example embodiments.

### DETAILED DESCRIPTION

Hereinafter, a text generating device, a text generating method, and/or a non-transitory computer-readable medium according to some example embodiments of the present disclosure will be described with reference to the accompanying drawings. The technical scope of the present disclosure is not limited to some example embodiments and reaches the scope provided by the appended claims and equivalents thereto.

### (Summary of Routine Which is Performed by Text Generating System 1)

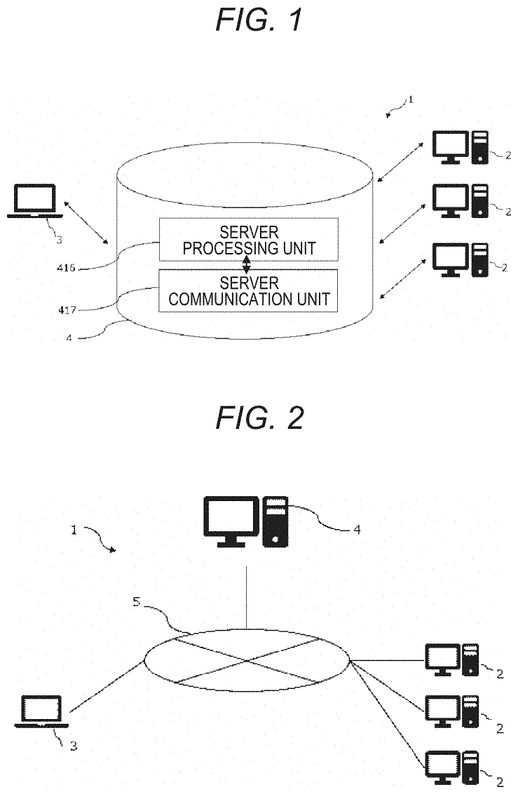

FIG. 1 is a diagram schematically illustrating an example of a routine which is performed by a text generating system 1.

According to some example embodiments, the text generating system 1 includes a plurality of user terminal devices 2, a patent document database 3, and a server 4 that communicates with the plurality of user terminal devices 2 and the patent document database 3. A server communication unit 417 of the server 4 receives invention text which is the subject matter of inventions serving as a basis for automatically generating additional invention text from the plurality of user terminal devices 2 by a user, and a server processing unit 416 generates the additional invention text on the basis of the received invention text and patent documents stored in the patent document database 3. More specifically, the server processing unit 416 may determine a first patent classification of invention text, select a second patent classification corresponding to the determined first patent classification, extract a patent document of the second patent classification similar to the invention text from the patent document database using the selected second patent classification, and generate additional invention text associated with the invention text on the basis of the extracted patent document of the second patent classification. Then, the server communication unit 417 may transmit the generated additional invention text to the user terminal devices 2. The number of pieces of invention text which is input by a user may be one (e.g., one piece of invention text) corresponding to an independent claim or may include a plurality of invention text pieces including invention text corresponding to dependent claims. In this example, a configuration in which one invention text piece corresponding to an independent claim is received is assumed, but some example embodiments are not limited to the configuration.

In some example embodiments, patent documents stored in the patent document database 3 are described as retrieval objects for similar patents similar to invention text, but a configuration in which the server 4 downloads patent documents from the patent document database 3 and the server 4 extracts similar patent documents may be employed. With this configuration, since processing may be completed locally, it is possible to enhance a processing speed.

The patent document database 3 is, for example, a database of a Patent Office. The database of the Patent Office may include a database of a single Patent Office or databases of two or more Patent Offices. Since about 90% of patents of the world may be covered by including databases of five Patent Offices of U.S.A, Europe, Japan, China, and Korea, the databases of the five Patent Offices may be included to enhance the determination accuracy of patentability.

### (Schematic Configuration of Text Generating System 1)

FIG. 2 is a diagram schematically illustrating an example of a configuration of the text generating system 1.

According to some example embodiments, the text generating system 1 includes a plurality of user terminal devices 2, a patent document database 3, and a server 4. In the following description, a plurality of user terminal devices may be simply referred to as a user terminal device 2. The user terminal devices 2 and the server 4 are connected to each other, for example, via a communication network such as the Internet 5. The patent document database 3 and the server 4 are connected to each other, for example, via a communication network such as the Internet 5. Only one Internet 5 is exemplified herein, but when the Internet 5 includes a plurality of networks, a gateway (not illustrated) may be appropriately provided between the networks. A program which is executed by the user terminal device 2 (for example, a browser program) and a program which is executed by the server 4 (for example, a management program) communicate with each other using a communication protocol such as the hypertext transfer protocol (HTTP).

Since information which is handled may be secret information, a communication environment of the Internet 5 for connection between the user terminal device 2 and the server 4, and connection between the patent document database 3 and the server 4, may be secure. By preparing dedicated lines, it is possible to enhance the security of the connection between the user terminal device 2 and the server 4, and the connection between the patent document database 3 and the server 4.

### (Schematic Configuration of User Terminal Device 2)

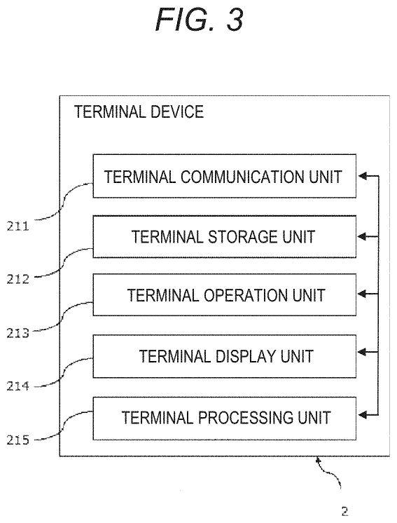

FIG. 3 is a diagram schematically illustrating an example of a configuration of a user terminal device 2.

The user terminal device 2 may perform an access to a radio communication network, a web access, and/or the like. According to some example embodiments, the user terminal device 2 may includes a terminal communication interface or unit 211, a terminal storage device or unit 212, a terminal operation interface or unit 213, a terminal display or display unit 214, and a terminal processing device or unit 215.

A tablet personal computer (PC) or a notebook PC may be used as the user terminal device 2, but some example embodiments are not limited thereto. The user terminal device 2 may be any of, for example, a multifunction mobile phone (a so-called “smartphone”), a mobile phone (a so-called “feature phone”), a personal digital assistant (PDA), a portable game machine, a portable music player, and/or a tablet terminal as long as some example embodiments may be applied thereto.

The terminal communication unit 211 may include a communication interface circuit and connect the user terminal device 2 to the Internet 5. According to some example embodiments, the communication interface circuit may be an Ethernet interface, an 802.11 (WiFi) interface, a Radio Frequency (RF) (e.g., cellular) interface, a Transmission Control Protocol/Internet Protocol (TCP/IP) interface, a Universal Serial Bus (USB) interface, a Bluetooth™ interface, etc., or any combination thereof. The terminal communication unit 211 may transmit data supplied from the terminal processing unit 215 to the server 4 or the like via the network. The terminal communication unit 211 may supply data from the server 4 or the like via the network to the terminal processing unit 215.

The terminal storage unit 212 may include (or be implemented using), for example, a semiconductor memory device. According to some example embodiments, the semiconductor memory device may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art. The terminal storage unit 212 may store an operating system program, a driver program, an application program, data, and/or the like which may be used for processing in the terminal processing unit 215. For example, the terminal storage unit 212 may store an input device driver program that controls the terminal operation unit 213, an output device driver program that controls the terminal display unit 214, and/or the like as the driver program. These various programs may be installed in the terminal storage unit 212 from a computer-readable portable recording medium such as a CD-ROM, or a DVD-ROM, using a known setup program or the like. The terminal storage unit 212 may temporarily store temporary data associated with predetermined or alternatively, given processes.

The terminal operation unit 213 may be any device able to operate the user terminal device 2 and may be, for example, a mouse, a touch panel, keyboard, and/or key buttons. A user may select or release information or input characters, numerals, or the like, using the terminal operation unit 213. When the terminal operation unit 213 is operated by a user, the terminal operation unit 213 may generate a signal corresponding to the operation. The generated signal may be transmitted to the terminal processing unit 215.

The terminal display unit 214 may be any device able to display a video, an image, or the like and may be, for example, a liquid crystal display or an organic electroluminescence (EL) display. The terminal display unit 214 may display a video based on video data supplied from the terminal processing unit 215, an image based on image data supplied therefrom, or the like.

The terminal processing unit 215 may include processing circuitry, for example, one or more processors and peripheral circuits thereof. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., or any combination thereof. The terminal processing unit 215 may comprehensively control the entire operation of the user terminal device 2 and may be, for example, a CPU. The terminal processing unit 215 may control the operation of the terminal communication unit 211, the terminal display unit 214, and/or the like such that various processes of the user terminal device 2 are performed in the appropriate order on the basis of a program stored in the terminal storage unit 212, the operation of the terminal operation unit 213, and/or the like. The terminal processing unit 215 may perform the processes on the basis of a program (the operating system program, the driver program, the application program, and/or the like) stored in the terminal storage unit 212, and thereby transform the terminal processing unit 215 into a special purpose processor specially programmed to provide the functionality embodied by the program. The terminal processing unit 215 may execute a plurality of programs (the application program and/or the like) in parallel.

The terminal processing unit 215 may have a function of processing screen display information received from the outside of the user terminal device 2 (e.g., an external source) as a screen display which may be browsed by a user, and a function of converting a process based on operation details of the terminal operation unit 213 which is performed by a user to a signal which may be transmitted to the outside of the user terminal device 2 and sending the converted signal to the terminal communication unit 211. These functions may correspond to functional modules which may be realized by a program executed by a processor of the terminal processing unit 215. Alternatively, the functional units may be mounted in the user terminal device 2 as independent integrated circuits, microprocessors, or firmware.

### (Process of User Terminal Device 2)

The user terminal device 2 may be operated by a user. The user may operate the terminal operation unit 213 to input invention text serving as a basis for generating additional invention text to the user terminal device 2. According to some example embodiments, the terminal processing unit 215 may correct an error of the invention text or correct the grammar thereof.

The user terminal device 2 may be a private terminal device for a user or may be a terminal device for a company or a network of a company as a whole.

### (Configuration of Patent Document Database 3)

The patent document database 3 may provide data of desired patent documents to the server 4 in response to a request from the server 4. That is, the patent document database 3 may extract results of retrieval corresponding to retrieval conditions received from the server 4 on the basis of the received retrieval conditions, and transmit data of patent documents which are the extracted results of retrieval to the server 4. The patent document database 3 may retrieve patent documents and transmit the retrieved patent documents to the server 4 when there is a request from the server 4, or the patent document database 3 may periodically transmit patent documents to the server 4 on the basis of a representative result of retrieval. Although not particularly illustrated, the patent document database 3 may include, or may only include a processing device or unit, a communication interface or unit, and/or a storage device or unit as elements of a server. According to some example embodiments, the processing unit of the patent document database 3 may be implemented using processing circuitry. According to some example embodiments, the communication unit of the patent document database 3 may be an Ethernet interface, a WiFi interface, an RF (e.g., cellular) interface, a TCP/IP interface, a USB interface, a Bluetooth™ interface, etc., or any combination thereof. According to some example embodiments, the storage unit of the patent document database 3 may be a tangible, non-transitory computer-readable medium, such as a RAM, a flash memory, a ROM, an EPROM, an EEPROM, registers, a hard disk, a removable disk, a CD ROM, any combination thereof, or any other form of storage medium known in the art.

When the server 4 also serves as the patent document database 3, the patent document database 3 may transmit data of patent documents to the server 4. The storage unit 411 or the like of the server 4 may store the data of the patent documents. The patent document database 3 may transmit data of patent documents to the server 4 in response to a request from the server 4 or may transmit data of patent documents to the server 4 by independent operation of the patent document database 3. In this case, since the server 4 may complete retrieval and determination within the server 4, it is possible to freely adjust a processing speed.

The patent document database 3 may cumulatively store unexamined patent publications and registered patent publications which are newly published. In the patent document database 3, all past patent documents may be itemized by, or only itemized by, entries. For example, each patent document may be divided into ABSTRACT, WHAT IS CLAIMED IS (CLAIMS), and/or full text. The text generating system 1 according to some example embodiments may perform full text search and free word search using a retrieval keyword included in the claims as will be described below.

### (Schematic Configuration of Server 4)

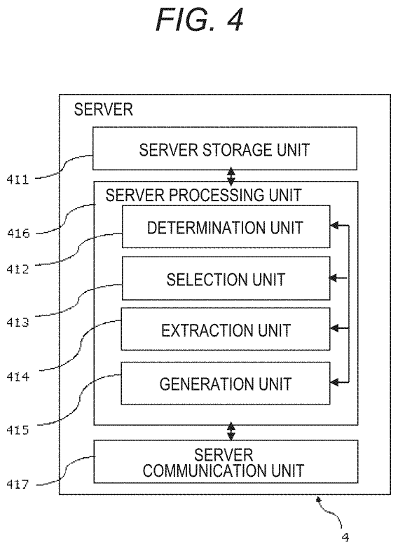

FIG. 4 is a diagram schematically illustrating an example of a configuration of the server 4. The server 4 may include a server storage unit 411 which is a storage area of the server 4. According to some example embodiments, the server 4 further include a server processing unit 416 including a determination unit 412, a selection unit 413, an extraction unit 414, and a generation unit 415. According to some example embodiments, the server processing device 416, the determination unit 412, the selection unit 413, the extraction unit 414, and/or the generation unit 415 may be implemented using processing circuitry. According to some example embodiments, the server 4 includes a server communication unit 417 for communication with the user terminal device 2 and/or the patent document database 3. The server storage unit 411 may include (or be implemented by), for example, at least one of a semiconductor memory, a magnetic disk device, and/or an optical disc device, and may be connected to the server 4 (e.g., in implementations in which the server storage unit 411 is external to the server 4), or connected to the server processing unit 416 or the server communication unit 417, via a bus. According to some example embodiments, the server storage unit 411 may be a tangible, non-transitory computer-readable medium, such as a RAM, a flash memory, a ROM, an EPROM, an EEPROM, registers, a hard disk, a removable disk, a CD ROM, or any other form of storage medium known in the art. The server storage unit 411 may store a driver program, an operating system program, an application program, data, and/or the like which may be used for processing in the server processing unit 416. For example, the server storage unit 411 may store a communication device driver program that controls the server communication unit 417 as the driver program. These computer programs may be installed in the server storage unit 411 from a computer-readable portable recording medium such as a CD-ROM, or a DVD-ROM, using a known setup program or the like. The server storage unit 411 may store a patent classification database which will be described below.

The server processing unit 416 may include the determination unit 412, the selection unit 413, the extraction unit 414, and/or the generation unit 415. The functional units of the server processing unit 416 may be functional modules which are realized by a program executed by a processor of the server processing unit 416, thereby transforming the server processing unit 416 into a special purpose processor specially programmed to provide the functionality embodied by the program. Alternatively, these functional units may be mounted in the server 4 as independent integrated circuits, microprocessors, or firmware. Process details of the server processing unit 416 will be described below. This partitioning of elements of the server processing unit 416 is only an example and which element performs which process is not limited to the description in some example embodiments.

The determination unit 412 may determine a first patent classification of invention text which is received from the user terminal device 2 by the server communication unit 417. Specifically, the determination unit 412 may determine the first patent classification using a word with a high appearance frequency out of a plurality of words included in the invention text, may retrieve patent documents including many words included in the invention text from the patent document database 3 and may determine a patent classification correlated with the extracted (e.g., retrieved) patent documents as the first patent classification of the invention text, or may determine the first patent classification using key terms from a dependency relation between words. According to some example embodiments, the determination unit 412 may determine the first patent classification by comparing a word appearing frequently in the invention text (and/or a word based on a dependency between words) to words associated with each of a plurality of patent classifications. Alternatively or additionally, the determination unit 412 may determine the first patent classification by determining patent documents containing similar words to the invention text and determining the classifications of the patent documents. That is, the first patent classification is determined to identify a patent classification to which invention text input by a user belongs. In general, one first patent classification is determined, but a plurality of first patent classifications may be determined for the invention text when it is difficult to narrow the number of first patent classifications to one. A technique of determining the first patent classification from input invention text may employ a known technique and is not limited to the aforementioned method.

The first patent classification may be a technical classification which is assigned to a patent document by the Patent Office, and File Indices (FIs) or International Patent Classifications (IPCs) may be used. Here, patent classifications such as United States Patent Classification (UPC) or File forming terms (F terms) may be used. For example, book classifications in libraries other than (e.g., different from) classifications prepared by the Patent Office may be used as long as the classifications are for classifying patent documents into different technical fields.

In some example embodiments, the configuration for determining the first patent classification may be provided for allowing the selection unit 413, which will be described below, to select a second patent classification, and the configuration of the determination unit 412 may not be used as long as the selection unit 413 is able to select a second patent classification without using the first patent classification.

The selection unit 413 may select a second patent classification corresponding to the first patent classification determined by the determination unit 412. The selection unit 413 may select a second patent classification corresponding to the first patent classification from a patent classification database (not illustrated) in which the first patent classifications stored in the server storage unit 411 and the second patent classifications are stored in correlation with each other. The extraction unit 414, of which details will be described below, may select a patent classification which is assigned to patent text of (e.g., within) the first patent classification (e.g., a patent document classified with the first patent classification), or a patent classification which is assigned to a prior art document correlated with (e.g., cited during prosecution of the patent) the patent text of (e.g., within) the first patent classification, as the second patent classification. In this case, the second patent classification may be determined not to overlap the first patent classification. As the second patent classification, a patent classification which is not similar to the first patent classification may be selected. For example, by excluding a patent classification (or reducing a number of patent classifications) matching a predetermined or alternatively, given number of digits from the head thereof, it is possible to select a non-similar patent classification. That is, the selection unit 413 may not be limited to the aforementioned selection method as long as the second patent classification may be selected at a predetermined or alternatively, given distance from the first patent classification in patent classifications. The predetermined or alternatively, given distance may be set to different values depending on technical classifications. For example, in the technical field of IT software, since many technical classifications across a plurality of classifications are determined to be basically combined easily, the predetermined or alternatively, given distance may be set to be large. That is, the patent classification database may store a first predetermined or alternatively, given number of digits (for example, four digits) from the head of a patent classification and a second predetermined or alternatively, given number of digits (for example, three digits) from the head of a patent classification for each patent classification. Here, the second predetermined or alternatively, given number of digits may be less than the first predetermined or alternatively, given number of digits. With this configuration, it is possible to extract patent text of the second patent classification included in the second patent classification which is appropriately close to the first patent classification by excluding a patent classification which is (or reducing a number of patent classifications which are) close to the first patent classification. For example, a patent classification which does not match the first predetermined or alternatively, given number of digits (for example, four digits) from the head of the patent classification but which matches the second predetermined or alternatively, given number of digits (for example, three digits) from the head may be selected as the second patent classification.

The second patent classification may be a technical classification which is assigned to a patent document by the Patent Office, and FIs or IPCs may be used. Here, patent classifications such as UPC or F terms may be used. For example, book classifications in libraries other than (e.g., different from) classifications prepared by the Patent Office may be used as long as the classifications are for classifying patent documents into different technical fields. Here, it the same type of patent classification as the first patent classification, or a similar type of patent classification, may be used as the second patent classification.

The extraction unit 414 may extract a patent document of the second patent classification which is similar to invention text from the patent document database 3 using the second patent classification selected by the selection unit 413. A known method may be used to extract the similar patent document. For example, by using a key term which is used by the determination unit 412 as a retrieval keyword, a patent document including the retrieval keyword may be extracted from the patent document database 3. More specifically, the extraction unit 414 may divide the received invention text into elements. Specifically, sub term analysis may be used. That is, invention text may be divided in units of a plurality of words and a dependency relation indicating which word modifies which word may be extracted. When the invention text is English or the like, a delimiter process of dividing text with priority order of a period, a colon, a semicolon, a comma, and a relative pronoun may be performed. A retrieval keyword may extracted out of a plurality of words included in the invention text. For example, a word with a high appearance frequency may be extracted as a retrieval keyword, and/or a key term may be extracted as a retrieval keyword from the dependency relation between words. That is, the retrieval keyword may be a term for expressing the technical field to which the invention text input by a user belongs as one word. The retrieval keyword may generally include one word, but may include a plurality of words, for example, when it is difficult to narrow the number of retrieval keywords to one, or the like.

When the extraction unit 414 extracts a patent document of the second patent classification, a patent document included in the patent document database 3 may be retrieved simply by keyword retrieval. For example, a patent document in which a retrieval keyword is described in a claim may be extracted as the result of retrieval, or a patent document in which a retrieval keyword is described in a first claim (e.g., a first independent claim) may be extracted as the result of retrieval.

The extraction unit 414 may enhance the accuracy of a patent document by considering of the priority of the retrieval keyword in the patent document including the retrieval keyword in order to enhance the accuracy of a patent document which is extracted. For example, the extraction unit 414 may evaluate the priority of the retrieval keyword in text included in the patent document using a Term Frequency-Inverse Document Frequency (TF-IDF) method or the like. Here, it is assumed that a retrieval keyword which appears in a patent document as a whole has low priority and it is assumed that a retrieval keyword which appears in only specific text in a patent document has high priority. Extraction of a patent document with a retrieval keyword using the TF-IDF method or the like may be performed when a user inputs invention text to the user terminal device 2 and a retrieval keyword is acquired, or patent documents for representative retrieval keywords may be stored in advance in the server storage unit 411.

The selection unit 413 may select a plurality of second patent classifications. The server communication unit 417 may transmit the plurality of second patent classifications to the user terminal device 2 and receive at least one second patent classification which is selectively input to the user terminal device 2 out of the plurality of second patent classifications by a user. The extraction unit 414 may extract patent text of the second patent classification similar to the invention text from the patent document database 3 using the selected at least one second patent classification.

The generation unit 415 may generate additional invention text associated with the invention text on the basis of the extracted patent text of the second patent classification. The generation unit 415 may generate additional invention text using information described in the claims of the patent text of the second patent classification and/or generate additional invention text using results of analysis of the whole patent text of the second patent classification. In some example embodiments, dependent claims of the patent text of the second patent classification may be provided to the user as additional invention text. When the extraction unit 414 determines that some of the dependent claims of the patent text of the second patent classification are similar to the invention text, a dependent claim which is determined not to be similar may be provided to the user as additional invention text.

The extraction unit 414 may extract patent text of a plurality of second patent classifications from the patent document database 3. The generation unit 415 may generate additional invention text associated with the invention text on the basis of patent text of the second patent classification which is most similar to the invention text out of the patent text of the plurality of second patent classifications (e.g., among a plurality of patent documents corresponding to the plurality of second patent classifications). According to some example embodiments, the generation unit 415 may generate additional invention text associated with the invention text based on the extracted patent document being most similar to the invention text among a plurality of patent documents corresponding to the selected second patent classification. The patent text of the second patent classification which is most similar may be determined on the basis of a match rate between similar retrieval keywords by the extraction unit 414 or may be on standby until the user selects the patent text using the user terminal device 2.

When the extraction unit 414 extracts patent text of the plurality of second patent classifications from the patent document database 3, the generation unit 415 may generate a common part, of parts which are not similar to the invention text in the patent text of the plurality of second patent classifications, as additional invention text. According to some example embodiments, the generation unit 415 may generate the additional invention text based on common text in a plurality of patents (e.g., from the patent document database 3) where the common text is common among the plurality of patents and dissimilar (e.g., different from) to the invention text. That is, the generation unit 415 may generate a configuration which is frequently used in the patent text of the plurality of second patent classifications extracted by the extraction unit 414 as additional invention text. Retrieval of a similar part between the patent text of the plurality of second patent classifications may be performed by the extraction unit 414 or the generation unit 415. The extraction unit 414 or the generation unit 415 may retrieve the similar part by comparing the patent text of the plurality of second patent classifications subjected to syntax analysis or may retrieve the similar part by comparing semantic concepts of words subjected to syntax analysis. The generation unit 415 may generate a result of determination of patentability of additional invention text associated with the invention text in the first patent classification as the additional invention text. According to some example embodiments, the additional invention text may include at least one claim, or at least one portion of a specification, of the patent text corresponding to the second patent classification. According to some example embodiments, the server processing unit 416 may generate a specification and/or claims of a patent application based on the invention text and the additional invention text. According to some example embodiments, the server processing unit 416 may generate a patent application including the generated specification and/or claims. According to some example embodiments, the server processing unit 416 may generate a signal corresponding to the specification and/or claims for the patent application (or the patent application including the specification and/or claims) and transmit the signal to the user terminal device 2. According to some example embodiments, the user terminal device 2 may generate the patent application including the specification and/or claims.

The generation unit 415 may generate text which is included in the patent text of the second patent classification and which is not included in the invention text as the additional invention text. That is, when the invention text includes a plurality of inventions or the like, a difference between the invention text and patent text of the second patent classification may be generated as the additional invention text.

The server communication unit 417 may include a communication interface circuit for connecting the server 4 to the Internet 5. According to some example embodiments, the communication interface circuit may be an Ethernet interface, a WiFi interface, an RF (e.g., cellular) interface, a TCP/IP interface, a USB interface, a Bluetooth™ interface, etc., or any combination thereof. The server communication unit 417 may receive invention text serving as a basis for requesting generation of additional invention text from the user terminal device 2 and transmit additional invention text generated by the generation unit 415 to the user terminal device 2. The server communication unit 417 may receive information of patent documents from the patent document database 3 according to circumstances. The server communication unit 417 may perform various types of communication with the user terminal device 2, according to circumstances, and perform various types of communication with the patent document database 3 according to circumstances. The server communication unit 417 may correspond to a reception unit and/or a transmission unit in the claims.

### (Process in Text Generating System 1)

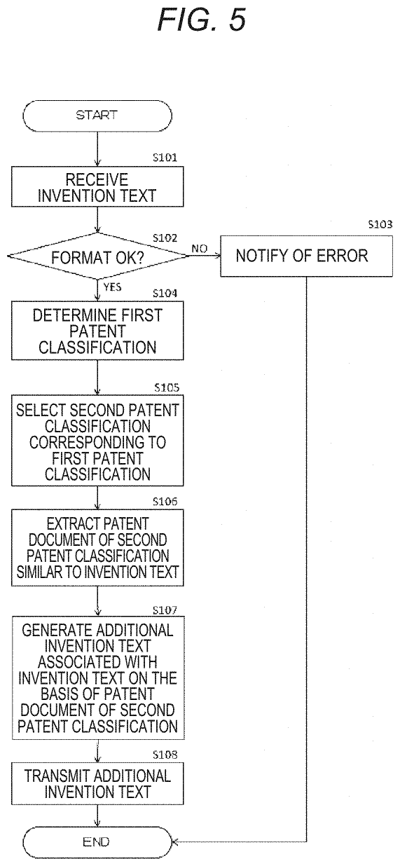

FIG. 5 is a diagram illustrating an example of an operation sequence of a flow of receiving invention text from a user terminal device 2, generating additional invention text, and transmitting the generated additional invention text to the user terminal device 2, which may be performed by the text generating system 1 according to some example embodiments.

The operation sequence which will be described below may be performed mainly (or entirely) by the server processing unit 416, for example, on the basis of a program stored in advance in the server storage unit 411 in cooperation with the constituents of the server 4. In the operation sequence which will be described below, the server 4 may transmit and receive various types of information to and from the patent document database 3 via the server communication unit 417.

First, the server communication unit 417 of the server 4 may receive invention text serving as a basis for automatically generating additional invention text from the user terminal device 2 (Operation S101). This operation sequence may be started when the server communication unit 417 receives invention text from the user terminal device 2.

Subsequently, the server processing unit 416 may determine whether the invention text is described in a format suitable for determining patentability thereof (Operation S102). For example, in some example embodiments, since the invention text should include one (or only one) invention, the server processing unit 416 may transmit error information to the user terminal device 2 via the server communication unit 417 when a plurality of commas are included in the text. When the invention text is described in an incorrect format (NO in Operation S102), the server processing unit 416 may transmit error information to the user terminal device 2 (Operation S103) and the operation sequence may end. Then, the server processing unit 416 may wait for reception of invention text of which the format has been corrected or next invention text. The process of Operation S102 may be skipped.

Subsequently, when the invention text is described in a correct format (YES in Operation S102), the server processing unit 416 may determine a first patent classification of the invention text received from the user terminal device 2 (Operation S104). The server storage unit 411 may temporarily store the determined first patent classification.

Subsequently, the server processing unit 416 may select a second patent classification corresponding to the determined first patent classification (Operation S105). In consideration of a load of the server 4, the server processing unit 416 may select the second patent classification with reference to the patent classification database in which the second patent classification corresponding to the first patent classification is stored. The second patent classification corresponding to the first patent classification in the patent classification database may be automatically updated according to patent classifications assigned to patent document stored in the patent document database 3. That is, a distance between patent classifications may have an appropriate value. An excessively short distance may correspond to denial of patentability, and an excessively long distance may cause apparently different fields as an additional invention, which may be meaningless. As described above, various methods may be employed as the method of selecting the second patent classification corresponding to the first patent classification. For example, the server processing unit 416 may extract a patent classification which does not match a first predetermined (or alternatively, given) number of digits (for example, four digits) from the head of the determined patent classification but which matches a second predetermined (or alternatively, given) number of digits (for example, three digits) from the head as the second patent classification from the patent document database.

Then, the server processing unit 416 may extract a patent document of the second patent classification similar to the invention text from the patent document database 3 using the second patent classification (Operation S106). When patent documents are stored in the server storage unit 411, the server processing unit 416 may extract a patent document of the second patent classification similar to the invention text from the server storage unit 411.

The server processing unit 416 may generate additional invention text associated with the invention text on the basis of the extracted patent document of the second patent classification (Operation S107). The server processing unit 416 may combine the invention text and the additional invention text into a format of a claims group. Then, the server communication unit 417 may transmit the generated additional invention text to the user terminal device 2 (Operation S108). The server communication unit 417 may transmit the invention text received in Operation S101 to the user terminal device 2 in addition to the additional invention text.

As described above, the text generating system 1 according to some example embodiments may automatically generate an additional invention from invention text serving as a basis for automatically generating additional invention text from a plurality of user terminal devices 2. Since the text generating system 1 according to some example embodiments may generate the additional invention text on the basis of a patent document to which a second patent classification which is not excessively close to the first patent classification into which the invention text is classified and which is not excessively far therefrom is assigned, it is possible to generate additional invention text from a patent document which is not likely to serve as a patent document for denying patentability at the time of determination of patentability. In the text generating system 1, information is updated from time to time in consideration of patent classifications assigned to patent documents actually stored in the patent document database 3. Accordingly, since additional invention text is generated on the basis of a patent document of the second patent classification extracted on the basis of the patent classifications assigned to newer patent documents, it is possible to generate additional invention text which is suitable for examination in the Patent Office.

Some example embodiments provide the text generating system 1 as a system in which the user terminal device 2, the patent document database 3, and the server 4 are independent, but the same advantages or similar advantages may be achieved in a determination device in which the functions are collected in one place. Some example embodiments may also provide a program for installing these functions in a user terminal device or the like.

Conventional devices for generating a specification and/or claims of a patent application are unable to build on invention text (e.g., received from an inventor) to improve the patentability of the invention test by, for example, increasing claim scope, adding detail to specification, etc.. Accordingly, the conventional devices generate specifications and/or claims of insufficient quality by limiting the specifications and/or claims to information contained in the invention text.

However, according to some example embodiments, improved devices are provided for generating a specification and/or claims of a patent application. For example, the improved devices may build on the invention text using additional invention text included in at least one patent document. Accordingly, the improved devices may overcome the deficiencies of the conventional devices to improve the patentability of the invention text (e.g., increase claim scope, add detail to the specification, etc.), and thereby improve the quality of the generated specification and/or claims.

Those skilled in the art should understand that some example embodiments may be subjected to various modifications, substitutions, and corrections without departing from the spirit and scope of some example embodiments. In modified examples which will be described below, it should also be understood that the modified examples may be combined to in some example embodiments.

### MODIFIED EXAMPLE 1

The server communication unit 417 may be configured to receive invention text from a user terminal device 2, but the server communication unit 417 may receive challenge text (e.g., text descripting a challenge that the invention described in the invention text is intended to solve) in addition to the invention text. By additionally receiving challenge text, the determination unit 412 may determine a patent classification on the basis of retrieval keywords included in the challenge text and the invention text. Accordingly, the determination unit 412 may enhance the accuracy of a patent classification which is determined. In some example embodiments, it may be possible to enhance the accuracy of a patent classification which is determined by the determination unit 412 by receiving challenge text, and text other than the challenge text, from the user terminal device 2.

### MODIFIED EXAMPLE 2

The extraction unit 414 may extract a patent document including a retrieval keyword from the patent document database 3 using a key term in invention text as the retrieval keyword, but it may be possible to extract a patent document including a retrieval keyword from the patent document database 3 using a key term as the retrieval keyword on the basis of the challenge text and the invention text.

In this case, the extraction unit 414 may extract a patent document of the second patent classification by comparing the invention text received from the user terminal device 2 with claims of patent documents stored in the patent document database 3, but may additionally compare a challenge text received from the user terminal device 2 and challenges in patent documents stored in the patent document database 3 in addition to the invention text and the claims of the patent documents stored in the patent document database 3. Since similarity between text pieces as a whole may be determined to be high when the number of similar text pieces (entries of the text) is large, it is possible to enhance the accuracy for extraction of a patent document of the second patent classification which is performed by the extraction unit 414.

What is claimed is:

1. A text generating device comprising:
at least one processor; and
at least one memory including computer program code,
wherein the at least one memory and the computer program code are configured to, with the at least one processor, cause the text generating device to,
determine a first patent classification of invention text;
select a second patent classification corresponding to the first patent classification;
extract a patent document corresponding to the second patent classification from a patent document database, the patent document being similar to the invention text;
generate additional invention text associated with the invention text based on the patent document, the additional invention text being included in the patent document and not included in the invention text; and
transmit the additional invention text to a terminal device.

2. The text generating device according to claim 1, wherein
the text generating device further comprises a patent classification database configured to store the first patent classification and the second patent classification in correlation with each other; and
the at least one memory and the computer program code are configured to, with the at least one processor, cause the text generating device to select the second patent classification from the patent classification database.

3. The text generating device according to claim 1, wherein the at least one memory and the computer program code are configured to, with the at least one processor, cause the text generating device to:
extract patent text of the first patent classification from the patent document database, the patent text being similar to the invention text; and
select a patent classification assigned to the patent text or a patent classification assigned to a prior art document correlated with the patent text as the second patent classification.

4. The text generating device according to claim 1, wherein the at least one memory and the computer program code are configured to, with the at least one processor, cause the text generating device to:
select a plurality of second patent classifications including the second patent classification;
transmit the plurality of second patent classifications to the terminal device;
receive an input selection of at least one selected second patent classification among the plurality of second patent classifications from the terminal device; and
extract the patent document corresponding to the selected second patent classification.

5. The text generating device according to claim 1, wherein the at least one memory and the computer program code are configured to, with the at least one processor, cause the text generating device to extract the patent document from the patent document database based on the patent document being most similar to the invention text among a plurality of patent documents corresponding to the second patent classification.

6. The text generating device according to claim 1, wherein the at least one memory and the computer program code are configured to, with the at least one processor, cause the text generating device to:
extract a plurality of patent documents corresponding to a plurality of second patent classifications from the patent document database, the plurality of patent documents including the patent document, and the plurality of second patent classifications including the second patent classification; and
generate the additional invention text based on common text in the plurality of patent documents, the common text being common among the plurality of patent documents and dissimilar to the invention text.

7. The text generating device according to claim 1, wherein the at least one memory and the computer program code are configured to, with the at least one processor, cause the text generating device to generate a specification of a patent application or at least one claim of the patent application based on the invention text and the additional invention text.

8. The text generating device according to claim 7, wherein the at least one memory and the computer program code are configured to, with the at least one processor, cause the text generating device to:
generate a signal corresponding to the specification or the at least one claim; and
transmit the signal to the terminal device.

9. A text generating method performed by a computer, the text generating method comprising:
determining a first patent classification of invention text;
selecting a second patent classification corresponding to the first patent classification;
extracting a patent document corresponding to the second patent classification from a patent document database, the patent document being similar to the invention text;
generating additional invention text associated with the invention text based on the patent document; and
transmitting the additional invention text to a terminal device.

10. The text generating method according to claim 9, wherein
the method further comprises storing the first patent classification and the second patent classification in correlation with each other in a patent classification database; and
the selecting selects the second patent classification from the patent classification database.

11. The text generating method according to claim 9, wherein
the extracting extracts patent text of the first patent classification from the patent document database, the patent text being similar to the invention text; and
the selecting selects a patent classification assigned to the patent text or a patent classification assigned to a prior art document correlated with the patent text as the second patent classification.

12. The text generating method according to claim 9, wherein
the selecting selects a plurality of second patent classifications including the second patent classification;
the method further comprises,
transmitting the plurality of second patent classifications to the terminal device;
receiving an input selection of at least one selected second patent classification among the plurality of second patent classifications from the terminal device; and
the extracting extracts the patent document corresponding to the selected second patent classification.

13. The text generating method according to claim 9, wherein the extracting extracts the patent document from the patent document database based on the patent document being most similar to the invention text among a plurality of patent documents corresponding to the second patent classification.

14. The text generating method according to claim 9, wherein
the extracting extracts a plurality of patent documents corresponding to a plurality of second patent classifications from the patent document database, the plurality of patent documents including the patent document, and the plurality of second patent classifications including the second patent classification; and
the generating generates the additional invention text based on common text in the plurality of patent documents, the common text being common among the plurality of patent documents and dissimilar to the invention text.

15. A non-transitory computer-readable medium storing a text generating program that, when executed by a computer, causes a device including the computer to:
determine a first patent classification of invention text;
select a second patent classification corresponding to the first patent classification;
extract a patent document corresponding to the second patent classification from a patent document database, the patent document being similar to the invention text;
generate additional invention text associated with the invention text based on the patent document; and
transmit the additional invention text to a terminal device.

16. The non-transitory computer-readable medium according to claim 15, wherein
the device includes a patent classification database configured to store the first patent classification and the second patent classification in correlation with each other; and
the text generating program, when executed by the computer, causes the device to select the second patent classification from the patent classification database.

17. The non-transitory computer-readable medium according to claim 15, wherein the text generating program, when executed by the computer, causes the device to:
extract patent text of the first patent classification from the patent document database, the patent text being similar to the invention text; and
select a patent classification assigned to the patent text or a patent classification assigned to a prior art document correlated with the patent text as the second patent classification.

18. The non-transitory computer-readable medium according to claim 15, wherein the text generating program, when executed by the computer, causes the device to:
select a plurality of second patent classifications including the second patent classification;
transmit the plurality of second patent classifications to the terminal device;
receive an input selection of at least one selected second patent classification among the plurality of second patent classifications from the terminal device; and
extract the patent document corresponding to the selected second patent classification.

19. The non-transitory computer-readable medium according to claim 15, wherein the text generating program, when executed by the computer, causes the device to extract the patent document from the patent document database based on the patent document being most similar to the invention text among a plurality of patent documents corresponding to the second patent classification.

20. The non-transitory computer-readable medium according to claim 15, wherein the text generating program, when executed by the computer, causes the device to:
extract a plurality of patent documents corresponding to a plurality of second patent classifications from the patent document database, the plurality of patent documents including the patent document, and the plurality of second patent classifications including the second patent classification; and
generate the additional invention text based on common text in the plurality of patent documents, the common text being common among the plurality of patent documents and dissimilar to the invention text.
